(19) United States
(12) Patent Application Publication
(10) Pub. No.: US 2008/0132627 A1
(43) Pub. Date: Jun. 5, 2008

(54) Impact-Resistant Poly(Meth)Acrylate Moulding Masses With High Thermal Stability

(75) Inventors: Klaus Schultes, Wiesbaden (DE); Klaus Albrecht, Mainz (DE); Eric Reinheimer, Gross-Zimmern (DE); Thorsten Goldacker, Rossdorf (DE); Werner Hoss, Shanghai (CN); Michael Wicker, Seeheim-Jugenheim (DE); Anton Halblander, Griesheim (DE)

Correspondence Address: OBLON, SPIVAK, MCCLELLAND MAIER & NEUSTADT, P.C., 1940 DUKE STREET, ALEXANDRIA, VA, 22314, US

(73) Assignee: Roehm GmbH, Darmstadt (DE)

(21) Appl. No.: 11/813,946

(22) PCT Filed: Dec. 15, 2005
(86) PCT No.: PCT/EP05/13514

§ 371 Date: Jul. 13, 2007

(30) Foreign Application Priority Data
Jan. 24, 2005 (DE) 10 2005 003 302.4

(51) Int. Cl. C08L 33/10; C08K 5/05

(52) U.S. Cl. 524/385; 525/222; 524/523; 525/64

(57) ABSTRACT

The invention relates to a polymer mixture, based on the (meth)acrylate (co)polymer components a.), b.), c.) and/or d.) according to claim 1, where a test specimen produced from the polymer mixture simultaneously has the following properties:
a tensile modulus (ISO 527) of at least 2 500 MPa,
a Vicat softening point VSP (ISO 306-350) of at least 110° C.,
an impact resistance (ISO 179-2D, flatwise) of at least 30 kJ/m², and
a melt index MVR (ISO 1133, 230° C./3.8 kg) of at least 1.0 cm³/10 at least

The invention further relates to injection mouldings and to the use of the polymer mixture for production of injection mouldings.

The invention relates to an impact-resistant poly(meth)acrylate moulding composition (PMMA moulding composition) with high heat resistance and also to its use for injection mouldings.

### PRIOR ART

The demand for ever-lower fuel consumption is causing the automotive industry to make continual reductions in the deadweight of motor vehicles. Whereas steel parts were previously very substantially used in the motor-vehicle-exterior sector, there is a desire, for economic reasons, to produce these elements from materials with lower density, while at the same time reducing manufacturing cost.

The property profile of these mouldings is determined via lower deadweight together with high weathering resistance, high stiffness, good impact resistance, good dimensional stability, in particular also on heating within the long-term service temperature range, good chemicals resistance, e.g. with respect to cleaning products, good scratch resistance and high gloss.

Another shortcoming in the use of sheet steel, alongside its deadweight, is the disadvantage that the mouldings have to be subjected to a painting process after manufacture in order to achieve a “Class A” surface. Steel components are therefore being increasingly replaced by plastics components in order to reduce weight, while at the same time taking account of the desire of motor vehicle designers for more design freedom in relation to component geometry.

Various thermoplastics have hitherto been used in this sector, examples being polycarbonate (PC), ASA, ASA/PC, PMMA and glass fibre-filled polymers, e.g. GF polyamide.

Because the mouldings are generally produced by means of injection-moulding processes, another demand exists in relation to component geometry (long flow paths at low layer thicknesses) when thermoplastics are used: good flowability of the plastics melt, in order to eliminate reject parts. In order to give the motor vehicle producer substantially free choice of colour, the plastic should moreover possess very little intrinsic colour and have high light transmittance.

Although the use of glass fibre-reinforced plastics leads to mouldings with good mechanical properties, the requirement here, as with steel, is a subsequent painting process, in order to achieve uniform, glossy Class A surface quality.

Polycarbonate has not only high heat resistance but also very good toughness. However, a surface painting process is also needed here because of lack of weathering resistance, leading to yellowing, and low surface hardness. Another problem for the application mentioned is insufficient stiffness of this material.

Thermoplastic materials such as ASA, PMMA and blends composed of ASA with PC have better weathering resistance than polycarbonate. However, the requirements placed upon the components mentioned are not met with ASA and ASA/PC, because the stiffness of the material is inadequate, as is its surface hardness, which results in insufficient scratch resistance. PMMA is a material which has excellent weathering resistance and optical quality together with high stiffness, high surface hardness, good heat resistance and good melt flowability. However, the toughness of PMMA is too low for the application mentioned. In order to compensate for this shortcoming, PMMA can be optimized via blending with impact modifiers known from the prior art. However, this modification reduces heat resistance and surface hardness to the extent that even impact-modified PMMA does not meet the requirements.

There is a wide variety of commercially available moulding compositions based on polymethyl (meth)acrylate and having good properties.

### OBJECT AND ACHIEVEMENT OF OBJECT

A variety of commercially available moulding compositions based on polymethyl (meth)acrylate intrinsically have very satisfactory properties, but have the disadvantage that it is difficult to achieve uniformly all of the individual demands of a property profile demanded for production of high-quality injection mouldings, e.g. for exterior parts for automobiles. This has hitherto greatly restricted the possibilities for use of parts of this type. Because the mouldings very often have an opaque dark colour, they are subject to severe heating by insolation. An additional demand placed upon the PMMA moulding composition is therefore high heat resistance, in order that the moulding passes the appropriate climatic-conditions tests. No softening of the moulding is permitted here. Furthermore, the mouldings often have to be impact-resistant. Compliance with these demands is necessary not only for the installation of the mouldings on the automobile but also on grounds of long-term mechanical loading during the lifetime of the automobile (stone impact, weathering effects). The properties that are known to be good must moreover be retained, examples being processibility and mechanical properties.

It was therefore an object of the present invention to provide a thermoplastic material with a balanced property profile but without the disadvantages listed above.

The object is achieved via a polymer mixture which comprises the following components
a.) a low-molecular-weight (meth)acrylate (co)polymer,
   characterized by a solution viscosity in chloroform at 25° C. (ISO 1628—Part 6) smaller than or equal to 55 ml/g
b.) an impact modifier based on crosslinked poly(meth)acrylates
c.) a relatively high-molecular-weight (meth)acrylate (co) polymer,
   characterized by a solution viscosity in chloroform at 25° C. (ISO 1628—Part 6) greater than or equal to 65 ml/g and/or
d.) a (meth)acrylate (co)polymer other than a),
   characterized by a solution viscosity in chloroform at 25° C. (ISO 1628—Part 6) of from 50 to 55 ml/g
      where each of the components a.), b.), c.) and/or d.) can be treated as individual polymer or else as a mixture of polymers,
      where a.), b.), c.) and/or d.) give a total of 100% by weight,
      where the polymer mixture can also comprise conventional additives, conventional auxiliaries and/or conventional fillers and
      where a test specimen produced from the polymer mixture simultaneously has the following properties:
   a tensile modulus (ISO 527) of at least 2 500 MPa,
   a Vicat softening point VSP (ISO 306-50) of at least 110° C.,
   an impact resistance IR (ISO 179, edgewise) of at least 30 kJ/m², and
   a melt index MVR (ISO 1133, 230° C./3.8 kg) of at least 1.0 cm³/10 min.

### BRIEF DESCRIPTION OF THE INVENTION

### The Polymer Mixture

The invention provides a polymer mixture which comprises components a.), b.), and also c.) and/or d.). The polymer mixture can therefore be composed either of components a.), b.) and c.) or of components a.), b.) and d.) or of all four of the components. Each of components a.), b.), c.) and/or d.) may itself be present in the form of an individual polymer or else be present in the form of a mixture of two or more correspondingly defined polymers.

### Properties of the Polymer Mixture

The selection of the quantitative proportions and of the constitution of components a.), b.) and also c.) and/or d.) is such that a test specimen produced from the polymer mixture simultaneously has the following properties:
a tensile modulus (ISO 527) of at least 2 500 MPa, preferably at least 2 600 MPa, particularly preferably at least 2 700 or 2 800 MPa,
a Vicat softening point VSP (ISO 306-B50) of at least 110° C., preferably at least 111° C., particularly at least 112° C., e.g. from 110 to 125° C.,
an impact resistance IR (ISO 179, edgewise) of at least 30 kJ/m², preferably at least 32, 34, 37 or 40 kJ/m²
a melt index MVR (ISO 1133, 230° C./3.8 kg) of at least 1.0 cm³/10 min, preferably at least 1.2, 1.5 or 2.0 cm³/10 min.

The selection of conventional additives, conventional auxiliaries and/or conventional fillers is such as to give, if possible, no impairment, or at most very slight impairment, of the abovementioned property profile.

### Other Properties

The selection of the quantitative proportions and of the constitution of components a.), b.) and also c.) and/or d.) can moreover be such that a test specimen produced from the polymer mixture also at least has some of the following properties:

### Study of Stress Cracking on Exposure to Solvent

A test strip of thickness d is clamped onto a circular curved jig of radius r. This produces an outer fibre strain eps=d/(2r+d) in that surface of the test specimen subject to tension. The arrangement corresponds to the structure in ISO 4599. That surface of the test specimen subject to tension is wetted with the solvent. The time needed to produce cracks is measured, by means of visual observation with the naked eye (i.e. without microscope or the like). If various jigs are used with different radius r, time needed to produce cracking can be determined for different outer fibre strains. This generally falls as outer fibre strain increases.
Fracture time on wetting of surface with isopropanol at constant outer fibre strain of
   0.39%: >1 800 s
   0.50%: >700 s
Fracture time on wetting of surface with ethanol/water mixture at 70:30 ratio with constant outer fibre strain of
   0.39%: >1 800 s
   0.50%: >200 s

### Surface Hardness

Taber scratch hardness with an applied force of
   0.7 N: no detectable surface damage,
   1.5 N: <2.0 μm, preferably <1.6 μm,
   3.0 N: <6 μm, preferably <5 μm,

### Surface Gloss

R(60°): >48%, preferably >50%

### Quantitative Ratios of Components

The quantitative ratios of the components are as follows, giving a total of 100% by weight.

Component a.): from 25% by weight to 75% by weight, preferably from 40% by weight to 60% by weight, in particular from 45% by weight to 57% by weight.

Component b.): from 7% by weight to 60% by weight, preferably from 7% by weight to 20% by weight.

Component c.) and/or d.): from 10% by weight to 50% by weight, preferably from 12% by weight to 44% by weight.

Test specimens with very high VSP values in the range from 116 to 120° C. can be obtained if the amount of c.) present is from 30% by weight to 45% by weight, preferably from 35% by weight to 40% by weight, and d.) is preferably absent.

Test specimens with high VSP values, in the range from 114 to 118° C., can be obtained if both c.) and d.) are present, their quantitative proportions preferably being from 10% by weight to 15% by weight of c.) and from 15% by weight to 25% by weight of d.).

Test specimens with VSP values in the range from 109° C. to 113° C. and simultaneously with very little intrinsic colour can be obtained if the amount of d.) present is from 30% by weight to 40% by weight, preferably from 33% by weight to 38% by weight and c.) is preferably absent.

The polymer mixture can also comprise conventional additives, conventional auxiliaries and/or conventional fillers.

### Preparation of the Polymer Mixture

The polymer mixture can be prepared via dry blending of the components, which may take the form of powders, grains or preferably pellets.

The polymer mixture can also be processed via melting and mixing of the individual components in the melt or via melting of dry premixes of the individual components to give a ready-to-use moulding composition. By way of example, this may take place in single- or twin-screw extruders. The resultant extrudate can then be pelletized. Conventional additives, conventional auxiliaries and/or conventional fillers can be directly admixed or subsequently added by the end consumer as required.

### Component a.)

Component a.) is a low-molecular-weight (meth)acrylate (co)polymer, characterized by a solution viscosity in chloroform at 25° C. (ISO 1628—Part 6) smaller than or equal to 55 ml/g, preferably smaller than or equal to 50 ml/g, in particular from 45 to 55 ml/g.

This can correspond to a molar mass M_{w} (weight average) of 95 000 g/mol (M_{w} determined by means of gel permeation chromatography, based on polymethyl meth-acrylate as calibration standard). The molecular weight Mw can be determined by way of example by gel permeation chromatography or by a light scattering method (see by way of example H. F. Mark et al., Encyclopedia of Polymer Science and Engineering, 2nd Edition, Vol. 10, pp. 1 et seq., J. Wiley, 1989).

Component a.) is preferably a copolymer composed of methyl methacrylate, styrene and maleic anhydride.

Suitable quantitative proportions by way of example can be:
from 50% by weight to 90% by weight, preferably from 70% by weight to 80% by weight, of methyl methacrylate,
from 10% by weight to 20% by weight, preferably from 12% by weight to 18% by weight, of styrene and
from 5% by weight to 15% by weight, preferably from 8% by weight to 12% by weight, of maleic anhydride.

Corresponding copolymers can be obtained in a manner known per se via free-radical polymerization. EP-A 264 590 describes by way of example a process for preparation of a moulding composition composed of a monomer mixture composed of methyl methacrylate, vinylaromatic, maleic anhydride, and also, where appropriate, of a lower alkyl acrylate, in which the polymerization process is carried out to a conversion of 50% in the presence or absence of a non-polymerizable organic solvent, and in which the polymerization process is continued from a conversion of at least 50% in the temperature range from 75 to 150° C. in the presence of an organic solvent to a conversion of at least 80%, and then the low-molecular-weight volatile constituents are evaporated.

JP-A 60-147 417 describes a process for preparation of a highly heat-resistant polymethacrylate moulding composition, in which a monomer mixture composed of methyl methacrylate, of maleic anhydride and of at least one vinylaromatic is fed into, and polymerized at a temperature of from 100 to 180° C. in a polymerization reactor suitable for solution polymerization or for bulk polymerization. DE-A 44 40 219 describes another preparation process.

By way of example, component a.) can be prepared by mixing a monomer mixture composed of, by way of example, 6355 g of methyl methacrylate, 1271 g of styrene and 847 g of maleic anhydride with 1.9 g of tert-butyl perneodecanoate and 0.85 g of tert-butyl 3,5,5-trimethylperoxyhexanoate as polymerization initiator and 19.6 g of 2-mercaptoethanol as molecular weight regulator, and also with 4.3 g of palmitic acid. The resultant mixture can be charged to a polymerization cell and devolatilized by way of example for 10 minutes. The mixture can then be polymerized in a water bath by way of example for 6 hours at 60° C., then for 30 hours at 55° C. water bath temperature. After about 30 hours, the polymerization mixture reaches its maximum temperature of about 126° C. Once the polymerization cell has been removed from the water bath, the polymer corresponding to component a) is then heat-conditioned in the polymerization cell for about 7 hours, e.g. at 117° C. in an air cabinet.

### Component b.)

Component b.) is an impact modifier based on crosslinked poly(meth)acrylates. Component b.) preferably has a core/shell/shell structure.

Impact modifiers for polymethacrylate plastics are well known. Preparation and structure of impact-modified polymethacrylate moulding compositions are described by way of example in EP-A 0 113 924, EP-A 0 522 351, EP-A 0 465 049, EP-A 0 683 028 and U.S. Pat. No. 3,793,402.

Preferred impact modifiers are polymer particles which have a core-shell-shell structure and which can be obtained via emulsion polymerization (see, by way of example, EP-A 0 113 924, EP-A 0 522 351, EP-A 0 465 049 and EP-A 0 683 028). Typical particle sizes (diameters) of these emulsion polymers are in the range from 100 to 600 nm, preferably from 200 to 500 nm.

A three-layer or three-phase structure with a core and with two shells can be created as follows. An innermost (hard) shell can be substantially composed of methyl methacrylate, of very small proportions of comonomers, such as ethyl acrylate, and of a proportion of crosslinking agent, e.g. allyl methacrylate. The central (soft) shell can by way of example be composed of butyl acrylate and of styrene, while the outermost (hard) shell in essence mostly corresponds to the matrix polymer, thus giving compatibility and good coupling to the matrix.

For the purposes of the present invention, the wording “(meth)acrylates” here denotes acrylates, methacrylates and mixtures of the two. They therefore encompass compounds which have at least one group of the following formula

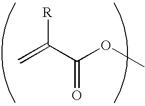

where R is hydrogen or a methyl radical. They include in particular alkyl acrylates and/or alkyl methacrylates.

The core preferably encompasses, based in each case on its total weight,
A) from 50.0% by weight to 99.9% by weight, advantageously from 60.0% by weight to 99.9% by weight, preferably from 75.0% by weight to 99.9% by weight, particularly preferably 80.0% by weight to 99.0% by weight, particularly from 85.0% by weight to 99.0% by weight, of alkyl methacrylate repeat units having from 1 to 20, preferably from 1 to 12, in particular from 1 to 8 carbon atoms in the alkyl radical,
B) from 0.0% by weight to 40.0% by weight, preferably from 0.0% by weight to 24.9% by weight, advantageously from 1.0% by weight to 29.9% by weight, in particular from 1.0% by weight to 14.9% by weight, of alkyl acrylate repeat units having from 1 to 20, preferably from 1 to 12, particularly preferably from 1 to 8, in particular from 1 to 4, carbon atoms in the alkyl radical,
C) from 0.1% by weight to 2.0% by weight of crosslinking repeat units and
D) from 0.0% by weight to 8.0% by weight of styrenic repeat units of the general formula (I)

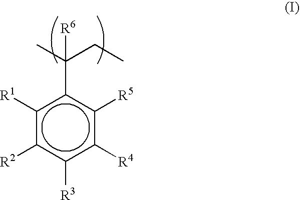

where the stated percentages by weight preferably give a total of 100.0% by weight.

These compounds A), B), C) and D) are naturally different from one another, and in particular the compounds A) and B) comprise no crosslinking monomers C).

Each of the radicals R¹ to R⁵ is, independently of the others, hydrogen, a halogen, in particular fluorine, chlorine or bromine, or an alkyl group having from 1 to 6 carbon atoms, preferably hydrogen. The radical R⁶ is hydrogen or an alkyl group having from 1 to 6 carbon atoms, preferably hydrogen. Particularly suitable alkyl groups having from 1 to 6 carbon atoms are methyl, ethyl, n-propyl, isopropyl, n-butyl, sec-butyl, tert-butyl, n-pentyl, n-hexyl groups and cyclopentyl and cyclohexyl groups.

In this way styrenic repeat units of the general formula (I) encompass repeat structural units which are obtainable by polymerization of monomers of the general formula (Ia).

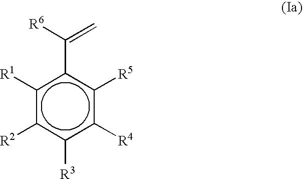

Suitable monomers of the general formula (Ia) in particular encompass styrene, substituted styrenes having an alkyl substituent in the side chain, for example α-methylstyrene and α-ethylstyrene, substituted styrenes having an alkyl substituent on the ring, for example vinyltoluene and p-methylstyrene, halogenated styrenes, for example monochlorostyrenes, dichloro-styrenes, tribromostyrenes and tetrabromostyrenes.

The abovementioned alkyl methacrylate repeat units (A) comprise repeat structural units which are obtainable via polymerization of esters of methacrylic acid. Suitable esters of methacrylic acid encompass in particular methyl methacrylate, ethyl methacrylate, propyl methacrylate, isopropyl methacrylate, n-butyl methacrylate, sec-butyl methacrylate, tert-butyl methacrylate, pentyl methacrylate, hexyl methacrylate, heptyl methacrylate, octyl methacrylate, 2-octyl methacrylate, ethylhexyl methacrylate, nonyl meth-acrylate, 2-methyloctyl methacrylate, 2-tert-butyl-heptyl methacrylate, 3-isopropylheptyl methacrylate, decyl methacrylate, undecyl methacrylate, 5-methyl-undecyl methacrylate, dodecyl methacrylate, 2-methyl-dodecyl methacrylate, tridecyl methacrylate, 5-methyl-tridecyl methacrylate, tetradecyl methacrylate, pentadecyl methacrylate, hexadecyl methacrylate, 2-methylhexadecyl methacrylate, heptadecyl methacrylate, 5-isopropylheptadecyl methacrylate, 5-ethyloctadecyl methacrylate, octadecyl methacrylate, nonadecyl methacrylate, eicosyl methacrylate, cycloalkyl methacrylates, for example cyclopentyl methacrylate, cyclohexyl methacrylate, 3-vinyl-2-butylcyclohexyl methacrylate, cycloheptyl methacrylate, cyclooctyl methacrylate, bornyl methacrylate and isobornyl methacrylate.

In one particularly preferred embodiment of the present invention, the core comprises, based on its total weight, at least 50% by weight, advantageously at least 60% by weight, preferably at least 75% by weight, in particular at least 85% by weight, of methyl methacrylate repeat units.

The abovementioned alkyl acrylate repeat units (B) comprise repeat structural units which are obtainable via polymerization of esters of acrylic acid. Suitable esters of acrylic acid encompass in particular methyl acrylate ethyl acrylate, propyl acrylate, isopropyl acrylate, n-butyl acrylate, sec-butyl acrylate, tert-butyl acrylate, pentyl acrylate, hexyl acrylate, heptyl acrylate, octyl acrylate, 2-octyl acrylate, ethylhexyl acrylate, nonyl acrylate, 2-methyloctyl acrylate, 2-tert-butylheptyl acrylate, 3-isopropylheptyl acrylate, decyl acrylate, undecyl acrylate, 5-methylundecyl acrylate, dodecyl acrylate, 2-methyldodecyl acrylate, tridecyl acrylate, 5-methyltridecyl acrylate, tetradecyl acrylate, pentadecyl acrylate, hexadecyl acrylate, 2-methylhexadecyl acrylate, heptadecyl acrylate, 5-isopropylheptadecyl acrylate, 5-ethyloctadecyl acrylate, octadecyl acrylate, nonadecyl acrylate, eicosyl acrylate, cycloalkyl acrylates, for example cyclopentyl acrylate, cyclohexyl acrylate, 3-vinyl-2-butylcyclohexyl acrylate, cycloheptyl acrylate, cyclooctyl acrylate, bornyl acrylate and isobornyl acrylate. The abovementioned crosslinking repeat units (C) comprise repeat structural units which are obtainable via polymerization of crosslinking monomers. Suitable crosslinking monomers encompass in particular all of the compounds which are capable, under the present polymerization conditions, of bringing about crosslinking. These include in particular
(a) Difunctional (meth)acrylates, preferably compounds of the general formula:

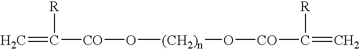

where R is hydrogen or methyl and n is a positive whole number greater than or equal to 2, preferably from 3 to 20, in particular di(meth)acrylates of propanediol, of butanediol, of hexanediol, of octanediol, of nonanediol, of decanediol, and of eicosanediol;
Compounds of the general formula:

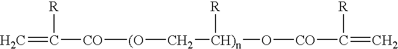

where R is hydrogen or methyl and n is a positive whole number from 1 to 14, in particular di(meth)acrylates of ethylene glycol, of diethylene glycol, of triethylene glycol, of tetraethylene glycol, of dodecaethylene glycol, of tetradecaethylene glycol, of propylene glycol, of dipropyl glycol, and of tetradecapropylene glycol. Glycerol di(meth)acrylate, 2,2′-bis[p-(γ-methacryloxy-β-hydroxypropoxy)phenylpropane] or bis-GMA, bisphenol A dimethacrylate, neopentyl glycol di(meth)acrylate, 2,2′-di(4-methacryloxypolyethoxyphenyl)propane having from 2 to 10 ethoxy groups per molecule and 1,2-bis(3-methacryloxy-2-hydroxypropoxy)butane.
(b) Tri- or polyfunctional (meth)acrylates, in particular
   trimethylolpropane tri(meth)acrylates and pentaerythritol tetra(meth)acrylate.
(c) Graft crosslinking agents having at least two C—C double bonds of differing reactivity, in particular allyl methacrylate and allyl acrylate;
(d) aromatic crosslinking agents, in particular 1,2-divinylbenzene, 1,3-divinylbenzene and 1,4-divinylbenzene.

The manner of selection of the proportions by weight of the constituents A) to D) of the core is preferably such that the core has a glass transition temperature Tg of at least 10° C., preferably of at least 30° C. The glass transition temperature Tg of the polymer here can be determined in a known manner by differential scanning calorimetry (DSC). The glass transition temperature Tg may also be approximated by means of the Fox equation. According to Fox T. G., Bull. Am. Physics Soc. 1, 3, p. 123 (1956):

$$\frac{1}{Tg} = \frac{{x}_{1}}{{Tg}_{1}} + \frac{{x}_{2}}{{Tg}_{2}} + … + \frac{{x}_{n}}{{Tg}_{n}}$$

where xₙ is the proportion by weight (% by weight/100) of the monomer n and Tgₙ is the glass transition temperature in kelvins of the homopolymer of the monomer n. The person skilled in the art may obtain further useful information from Polymer Handbook 2^{nd} Edition, J. Wiley & Sons, New York (1975), which gives Tg values for the homopolymers most commonly encountered.

The first shell of the inventive core-shell-shell particles has a glass transition temperature below 30° C., preferably below 10° C., in particular in the range from 0 to −75° C. The glass transition temperature Tg of the polymer here may be determined, as mentioned above, by means of differential scanning calorimetry (DSC) and/or approximated by means of the Fox equation.

The first shell encompasses, based on its total weight, the following constituents:
E) from 92.0% by weight to 98.0% by weight of (meth)acrylate repeat units and
F) from 2.0% by weight to 8.0% by weight of styrenic repeat units of the general formula (I),
   where the percentages by weight give a total of 100% by weight.

For the purposes of one very particularly preferred embodiment of the present invention, the first shell encompasses
E-1) from 90.0% by weight to 97.9% by weight of alkyl acrylate repeat units having from 3 to 8 carbon atoms in the alkyl radical and/or alkyl methacrylate repeat units having from 7 to 14 carbon atoms in the alkyl radical, in particular butyl acrylate repeat units and/or dodecyl methacrylate repeat units, and
E-2) from 0.1% by weight to 2.0% by weight of crosslinking repeat units,
F) from 2.0% by weight to 8.0% by weight of styrenic repeat units of the general formula (I),
   where the parts by weight preferably give a total of 100.0 parts by weight.

These compounds E-1), E-2) and F) naturally differ from one another, and in particular the compounds E-1) comprise no crosslinking monomers E-2).

The second shell encompasses, based on its total weight, at least 75% by weight of (meth)acrylate repeat units. It preferably contains
G) from 50.0% by weight to 100.0% by weight, advantageously from 60.0% by weight to 100.0% by weight, particularly preferably from 75.0% by weight to 100.0% by weight, in particular from 85.0% by weight to 99.5% by weight, of alkyl methacrylate repeat units having from 1 to 20, preferably from 1 to 12, in particular from 1 to 8, carbon atoms in the alkyl radical,
H) from 0.0% by weight to 40.0% by weight, preferably from 0.0% by weight to 25.0% by weight and in particular from 0.1% by weight to 15.0% by weight, of alkyl acrylate repeat units having from 1 to 20, preferably from 1 to 12, in particular from 1 to 8, carbon atoms in the alkyl radical,
I) from 0.0% by weight to 10.0% by weight, preferably from 0.0% by weight to 8.0% by weight, of styrenic repeat units of the general formula (I),
   where the stated percentages by weight preferably give a total of 100.0% by weight.

In one particularly preferred embodiment of the present invention, the second shell comprises, based on its total weight, at least 50% by weight, advantageously at least 60% by weight, preferably at least 75% by weight, in particular at least 85% by weight, of methyl methacrylate repeat units.

The manner of selection of constituents of the second shell is moreover advantageously such that the second shell has a glass transition temperature Tg of at least 10° C., preferably at least 30° C. The glass transition temperature Tg of the polymer here can be determined as mentioned above by differential scanning calorimetry (DSC) and/or approximated by the Fox equation.

The overall radius of the core-shell particle inclusive of any second shell present is in the range from greater than 160 to 260 nm, preferably in the range from 170 to 255 nm, in particular in the range from 175 to 250 nm. This overall radius is determined by the Coulter method. This method known from the literature for particle size determination is based on the measurement of the electrical resistance, which changes in a characteristic manner when particles pass through a narrow measuring aperture. Further details may be found by way of example in Nachr. Chem. Tech. Lab. 43, 553-566 (1995).

For the purposes of the present invention, furthermore, it has proven particularly advantageous if, based in each case on its total weight,
i) the proportion of the core is from 5.0% by weight to 50.0% by weight, preferably from 15.0% by weight to 50.0% by weight, advantageously from 25.0% by weight to 45.0% by weight, in particular from 30.0% by weight to 40.0% by weight,
ii) the proportion of the first shell is from 20.0% by weight to 75.0% by weight, preferably from 30.0% by weight to 60.0% by weight, advantageously from 35.0% by weight to 55.0% by weight, in particular from 40.0% by weight to 50% by weight, and
iii) the proportion of the second shell is from 0.0% by weight to 50.0% by weight, preferably from 5.0% by weight to 40.0% by weight, advantageously from 10.0% by weight to 30.0% by weight, in particular from 15.0% by weight to 25.0% by weight,
   where the percentages by weight preferably give a total of 100.0% by weight.

The core-shell particles of the invention may be prepared in a manner known per se, for example by means of multistage emulsion polymerization. This advantageously uses a method in which water and emulsifier are used to form an initial charge. This initial charge preferably comprises from 90.00 to 99.99 parts by weight of water and from 0.01 to 10.00 parts by weight of emulsifier, where the stated parts by weight advantageously give a total of 100.00 parts by weight.

The following sequence is then applied stepwise to this initial charge
b) the monomers for the core are added in the desired ratios and polymerized to a conversion of at least 85.0% by weight, preferably at least 90.0% by weight, advantageously at least 95.0% by weight, in particular at least 99% by weight, based in each case on their total weight,
c) the monomers for the first shell are added in the desired ratios and polymerized to a conversion of at least 85.0% by weight, preferably at least 90.0% by weight, advantageously at least 95.0% by weight, in particular at least 99% by weight, based in each case on the total weight thereof,
d) where appropriate, the monomers for the second shell are added in the desired ratios and polymerized to a conversion of at least 85.0% by weight, preferably at least 90.0% by weight, advantageously at least 95.0% by weight, in particular at least 99% by weight, based in each case on the total weight thereof.

For the purposes of the invention, polymers here are compounds whose molecular weight is at least 10 times that of the respective starting compound A) to I) known as the monomer.

The progress of the polymerization reaction into each step may be monitored in a known manner, for example gravimetrically or by means of gas chromatography.

According to the present invention, the polymerization in steps b) to d) is preferably carried out at a temperature in the range from 0 to 120° C., preferably in the range from 30 to 100° C.

Polymerization temperatures which have proven very particularly advantageous here are in the range from above 60 to below 90° C., advantageously in the range from above 70 to below 85° C., preferably in the range from above 75 to below 85° C.

Initiation of the polymerization takes place using the initiators commonly used for emulsion polymerization. Examples of suitable organic initiators are hydroperoxides, such as tert-butyl hydroperoxide or cumene hydroperoxide. Suitable inorganic initiators are hydrogen peroxide and the alkali metal and ammonium salts of peroxodisulphuric acid, in particular sodium peroxodisulphate and potassium peroxodisulphate. Suitable redox initiator systems by way of example are combinations of tertiary amines with peroxides or sodium disulphite and peroxodisulphates of alkali metals and of ammonium, in particular sodium peroxodisulphate and potassium peroxodisulphate, or particularly preferably peroxides. Further details may be found in the technical literature, in particular H. Rauch-Puntigam, Th. Völker, “Acryl-und Methacrylverbindungen” [Acrylic and methacrylic compounds], Springer, Heidelberg, 1967 or Kirk-Othmer, Encyclopedia of Chemical Technology, Vol. 1, pp. 386 et seq., J. Wiley, New York, 1978. For the purposes of the present invention, the use of organic and/or inorganic initiators is particularly preferred.

The initiators mentioned may be used either individually or else in a mixture. Their amount used is preferably from 0.05 to 3.0% by weight, based on the total weight of the monomers for the respective stage. It is also possible and preferable to carry out the polymerization using a mixture of various polymerization initiators of different half-life time, in order to keep the supply of free radicals constant during the course of the polymerization or at various polymerization temperatures.

The reaction mixture is preferably stabilized by means of emulsifiers and/or protective colloids. Preference is given to stabilization by emulsifiers, in order to obtain low dispersion viscosity. The total amount of emulsifier is preferably from 0.1 to 5% by weight, in particular from 0.5 to 3% by weight, based on the total weight of the monomers A) to I). Particularly suitable emulsifiers are anionic or non-ionic emulsifiers or mixtures of these, in particular:
alkyl sulphates, preferably those having from 8 to 18 carbon atoms in the alkyl radical, alkyl and alkyl-aryl ether sulphates having from 8 to 18 carbon atoms in the alkyl radical and from 1 to 50 ethylene oxide units;
sulphonates, preferably alkylsulphonates having from 8 to 18 carbon atoms in the alkyl radical, alkylarylsulphonates having from 8 to 18 carbon atoms in the alkyl radical, esters and half-esters of sulphosuccinic acid with monohydric alcohols or alkylphenols having from 4 to 15 carbon atoms in the alkyl radical; where appropriate, these alcohols or alkylphenols may also have been ethoxylated with from 1 to 40 ethylene oxide units;
partial esters of phosphoric acid and the alkali metal and ammonium salts of these, preferably alkyl and alkyl-aryl phosphates having from 8 to 20 carbon atoms in the alkyl and, respectively, alkyl-aryl radical and from 1 to 5 ethylene oxide units;
alkyl polyglycol ethers, preferably having from 8 to 20 carbon atoms in the alkyl radical and from 8 to 40 ethylene oxide units;
alkyl-aryl polyglycol ethers, preferably having from 8 to 20 carbon atoms in the alkyl and, respectively, alkyl-aryl radical and from 8 to 40 ethylene oxide units;
ethylene oxide-propylene oxide copolymers, preferably block copolymers, advantageously having from 8 to 40 ethylene oxide and, respectively, propylene oxide units.

According to the invention, preference is given to mixtures composed of anionic emulsifier and of non-ionic emulsifier. Mixtures which have proven very particularly successful here are those composed of an ester or half-ester of sulphosuccinic acid with monohydric alcohols or alkylphenols having from 4 to 15 carbon atoms in the alkyl radical, as anionic emulsifier, and of an alkyl polyglycol ether, preferably having from 8 to 20 carbon atoms in the alkyl radical and from 8 to 40 ethylene oxide units, as non-ionic emulsifier, in a ratio of from 8:1 to 1:8 by weight.

Where appropriate, the emulsifiers may also be used in a mixture with protective colloids. Suitable protective colloids encompass, inter alia, partially hydrolyzed polyvinyl acetates, polyvinylpyrrolidones, carboxy- methyl-, methyl-, hydroxyethyl-, hydroxypropyl-cellulose, starches, proteins, poly(meth)acrylic acid, poly(meth)acrylamide, polyvinylsulphonic acids, melamine-formaldehydesulphonates, naphthalene-formaldehydesulphonates, styrene-maleic acid copolymers and vinyl ether-maleic acid copolymers. If use is made of protective colloids, the amount preferably used of these is from 0.01 to 1.0% by weight, based on the total amount of the monomers A) to I). The protective colloids may be used to form an initial charge prior to the start of the polymerization, or may be metered in.

The initiator may be used to form an initial charge or may be metered in. Another possibility, furthermore, is use of a portion of the initiator to form an initial charge and metering-in of the remainder.

The polymerization is preferably initiated by heating the reaction mixture to the polymerization temperature and by metering-in of the initiator, preferably in aqueous solution. The feeds of emulsifier and monomers may be separate or take the form of a mixture. If mixtures composed of emulsifier and monomer are metered in, the procedure comprises premixing emulsifier and monomer in a mixer installed upstream of the polymerization reactor. It is preferable for the remainder of emulsifier and the remainder of monomer which are not used to form an initial charge to be metered in separately from one another after the start of the polymerization. The feed is preferably begun from 15 to 35 minutes after the start of the polymerization.

For the purposes of the present invention, furthermore, it is particularly advantageous for the initial charge to comprise what is known as a “seed latex”, which is preferably obtainable by polymerization of alkyl (meth)acrylates and moreover advantageously has a particle radius in the range from 3.0 to 20.0 nm. These small radii may be calculated after a defined polymerization onto the seed latex, during which a shell is built up around the seed latex, and measuring the radii of the resultant particles by the Coulter method. This method of particle size determination, known from the literature, is based on measurement of the electrical resistance, which changes in a characteristic manner when particles pass through a narrow measuring aperture. Further details may be found by way of example in Nachr. Chem. Tech. Lab. 43, 553-566 (1995).

The monomer constituents of the actual core, i.e. the first composition, are added to the seed latex, preferably under conditions such that the formation of new particles is avoided. The result of this is that the polymer formed in the first stage of the process is deposited in the form of a shell around the seed latex. Similarly, the monomer constituents of the first shell material (second composition) are added to the emulsion polymer under conditions such that the formation of new particles is avoided. The result of this is that the polymer formed in the second stage is deposited in the form of a shell around the existing core. This procedure is to be repeated appropriately for each further shell.

In another preferred embodiment of the present invention, the core-shell particles of the invention are obtained by an emulsion polymerization process in which, instead of the seed latex, a long-chain aliphatic alcohol, preferably having from 12 to 20 carbon atoms, emulsified, is used to form an initial charge. In one preferred embodiment of this process, the long-chain aliphatic alcohol used comprises stearyl alcohol. Similarly to the procedure described above, the core-shell structure is obtained by stepwise addition and polymerization of the corresponding monomers, avoiding the formation of new particles. The person skilled in the art can find further details on the polymerization process in the Patent Specifications DE 3343766, DE 3210891, DE 2850105, DE 2742178 and DE 3701579.

However, for the purposes of the present invention, irrespective of the specific procedure, it has proven very particularly advantageous for the second and the third monomer mixture to be metered in as required by consumption.

The chain length, in particular of the (co)polymers of the second shell, may be adjusted via polymerization of the monomer or of the monomer mixture in the presence of molecular weight regulators, for example in particular of the mercaptans known for this purpose, for example n-butyl mercaptan, n-dodecyl mercaptan, 2-mercaptoethanol or 2-ethylhexyl thioglycolate, pentaerythritol tetrathioglycolate; the amounts used of the molecular weight regulators generally being from 0.05 to 5% by weight, based on the monomer mixture, preferably from 0.1 to 2% by weight and particularly preferably from 0.2 to 1% by weight, based on the monomer mixture (cf., for example, H. Rauch-Puntigam, Th. Völker, “Acryl-und Methacrylverbindungen” [Acrylic and methacrylic compounds], Springer, Heidelberg, 1967; Houben-Weyl, Methoden der organischen Chemie [Methods of organic chemistry], Vol. XIV/1. p. 66, Georg Thieme, Heidelberg, 1961 or Kirk-Othmer, Encyclopedia of Chemical Technology, Vol. 1, pp. 296 et seq., J. Wiley, New York, 1978). The molecular weight regulator used preferably comprises n-dodecyl mercaptan.

After conclusion of the polymerization, post-polymerization may be carried out for residual monomer removal, using known methods, for example using initiated post-polymerization.

Since the process of the invention is particularly suitable for preparing aqueous dispersions with high solids content above 50% by weight, based on the total weight of the aqueous dispersion, the manner of selection of the relative proportions of all of the substances is advantageously such that the total weight of monomers, based on the total weight of the aqueous dispersion, is above 50.0% by weight, advantageously above 51.0% by weight, preferably above 52.0% by weight. The substances to be taken into account in this connection also include, besides the monomers, all of the other substances used, for example water, emulsifier, initiator, where appropriate regulators and protective colloids, etc.

The aqueous dispersions obtainable by the process of the invention feature a low coagulate content which, based on the total weight of the aqueous dispersion, is preferably less than 5.0% by weight, advantageously less than 3.0% by weight, in particular less than 1.5% by weight. In one particularly preferred embodiment of the present invention, the aqueous dispersion comprises, based on its total weight, less than 1.0% by weight, preferably less than 0.5% by weight, advantageously less than 0.25% by weight, in particular 0.10% by weight or less, of coagulate.

The term “coagulate” in this connection means water-insoluble constituents, which may preferably be filtered off by filtering the dispersion advantageously through a filter ruffle in which a No. 0.90 DIN 4188 filter fabric has been fixed.

The core-shell particle of the invention may be obtained from the dispersion for example by spray drying, freeze coagulation, precipitation by electrolyte addition or by exposure to mechanical or thermal stress, where the latter can be carried out by means of a vented extruder according to DE 27 50 682 A1 or U.S. Pat. No. 4,110,843. The process of spray drying is the most commonly used, but the other processes mentioned have the advantage that they provide at least some separation of the water-soluble polymerization auxiliaries from the polymer.

### Component c.)

Component c.) is an optional component which may be present alone or together with component d.).

Component c.) can be identical in terms of monomer make-up with component a.). Preparation can take place substantially analogously except that the polymerization parameters are selected in such a way as to give relatively high-molecular-weight polymers. This can by way of example be achieved via a reduction in the amount of molecular weight regulator used.

Component c.) is a relatively high-molecular-weight (meth)acrylate (co)polymer, characterized by a solution viscosity in chloroform at 25° C. (ISO 1628—Part 6) of greater than or equal to 65 ml/g, preferably from 68 to 75 ml/g. By way of example, it is possible to use Plexiglas® hw 55 moulding composition, prepared by Röhm GmbH & Co. KG.

This can correspond to a molar mass M_{w} (weight average) of 160 000 g/mol (M_{w} determined by means of gel permeation chromatography, based on polymethyl meth-acrylate as calibration standard). The molecular weight Mw can be determined by way of example by gel permeation chromatography or by a light scattering method (see by way of example H. F. Mark et al., Encyclopedia of Polymer Science and Engineering, 2nd Edition, Vol. 10, pp. 1 et seq., J. Wiley, 1989).

Component c.) can be identical in terms of monomer make-up with component a.). Component c.) is preferably a copolymer composed of methyl methacrylate, styrene and maleic anhydride.

Suitable quantitative proportions by way of example can be:
from 50% by weight to 90% by weight, preferably from 70% by weight to 80% by weight, of methyl methacrylate,
from 10% by weight to 20% by weight, preferably from 12% by weight to 18% by weight, of styrene and
from 5% by weight to 15% by weight, preferably from 8% by weight to 12% by weight, of maleic anhydride.

### Component d.)

Component d.) is an optional component which can be used alone or together with component c.).

Component d.) is another (meth)acrylate (co)polymer other than a.) and is characterized by a solution viscosity in chloroform at 25° C. (ISO 1628—Part 6) of from 50 to 55 ml/g, preferably from 52 to 54 ml/g. By way of example, it is possible to use Plexiglas® 8 n moulding composition, prepared by Röhm GmbH & Co. KG or the moulding composition.

This can correspond to a molar mass M_{w} (weight average) of from 80 000 to 200 000 (g/mol), preferably from 100 000 to 150 000. The molecular weight M_{w} can be determined by way of example by gel permeation chromatography or by a light scattering method (see by way of example H. F. Mark et al., Encyclopedia of Polymer Science and Engineering, 2nd Edition, Vol. 10, pp. 1 et seq., J. Wiley, 1989).

Component d.) is a homopolymer or copolymer composed of at least 80% by weight of methyl methacrylate and, where appropriate, up to 20% by weight of other monomers copolymerizable with methyl methacrylate. Component d.) is composed of from 80% by weight to 100% by weight, preferably from 90% by weight to 99.5% by weight, of methyl methacrylate units polymerized by a free-radical route, and, where appropriate, from 0% by weight to 20% by weight, preferably from 0.5% by weight to 10% by weight, of other comonomers capable of free-radical polymerization, e.g. C1-C4-alkyl (meth)acrylates, in particular methyl acrylate, ethyl acrylate or butyl acrylate. The average molar mass M_{w} of the matrix is preferably in the range from 90 000 g/mol to 200 000 g/mol, in particular from 100 000 g/mol to 150 000 g/mol.

Component d.) is preferably a copolymer composed of from 95% by weight to 99.5% by weight of methyl methacrylate and of from 0.5% by weight to 5% by weight, preferably from 1% by weight to 4% by weight, of methyl acrylate.

Component d.) can have a Vicat softening point VSP (ISO 306-B50) of at least 107° C., preferably from 108° C. to 114° C. Melt index MVR (ISO 1133, 230° C./3.8 kg) can by way of example be in the range greater than or equal to 2.5 cm³/10 min.

Conventional Additives, Conventional Auxiliaries and/or Conventional Fillers

The polymer mixture can also comprise, in a manner known per se, conventional additives, conventional auxiliaries and/or conventional fillers, e.g. heat stabilizers, UV stabilizers, UV absorbers, antioxidants.

For the injection moulding process, lubricants or mould-release agents are particularly important, and these can reduce or entirely prevent any possible adhesion of the polymer mixture to the injection mould.

Auxiliaries which can therefore be used are lubricants, e.g. selected from the group of the saturated fatty acids having fewer than C₂₀, preferably from C₁₆ to C₁₈, carbon atoms, or of the saturated fatty alcohols having fewer than C₂₀, preferably from C₁₆ to C₁₈, carbon atoms. Preference is given to very small quantitative proportions of at most 0.25% by weight, e.g. from 0.05 to 0.2% by weight, based on the polymer mixture.

Examples of suitable materials are stearic acid, palmitic acid, industrial mixtures composed of stearic and palmitic acid. Examples of other suitable materials are n-hexadecanol, n-octadecanol, and also industrial mixtures composed of n-hexadecanol and n-octadecanol.

Stearyl alcohol is a particularly preferred lubricant or mould-release agent.

### Injection Mouldings

The inventive polymer mixture can be used in a manner known per se to produce corresponding injection mouldings in the injection moulding process.

### Uses

The polymer mixture can be used to produce injection mouldings which have the following properties:
a tensile modulus (ISO 527) of at least 2 500 MPa, preferably at least 2 600 MPa, particularly preferably at least 2 700 MPa,
a Vicat softening point VSP (ISO 306-B50) of at least 110° C., preferably at least 111° C., particularly at least 112° C., e.g. from 110 to 125° C.,
an impact resistance IR (ISO 179, edgewise) of at least 30 kJ/m², preferably at least 40 kJ/m², and
a melt index MVR (ISO 1133, 230° C./3.8 kg) of at least 1.0 cm³/10 min, preferably at least 1.5 cm³/10 min.

The injection mouldings can be used as parts of household equipment, of communication equipment, of hobby equipment or of sports equipment, or as bodywork parts or as parts of bodywork parts in automobile construction, shipbuilding or aircraft construction. Typical examples of bodywork parts or parts of bodywork parts of automobiles are spoilers, panels, roof modules or exterior mirror housings.

### ADVANTAGEOUS EFFECTS OF THE INVENTION

The inventive polymer mixtures or inventive moulding compositions can be used to produce mouldings, in particular injection mouldings, which meet stringent materials demands, e.g. those existing for exterior parts of automobiles. Four particularly important demands have successfully been provided here simultaneously in orders of magnitude suitable for processing and use: tensile modulus, Vicat softening point, impact resistance and melt index. In particular, the good flowability brings about the processibility demanded in injection moulding, even when the geometries of the parts are difficult. It is surprising here that it is possible to obtain simultaneously injection mouldings of high toughness, of high weathering resistance, and of high heat resistance. In addition, a number of other desirable properties are achieved in an entirely satisfactory manner, e.g. chemicals resistance, yellowness index and intrinsic colour. The property profile can be adjusted individually to the demands in a particular instance by way of the mixing ratio of components a) to d).

### EXAMPLES

### Preparation of Component a.)

A monomer mixture composed of 6355 g of methyl methacrylate, 1271 g of styrene and 847 g of maleic anhydride is treated with 1.9 g of tert-butyl perneodecanoate and 0.85 g of tert-butyl 3,5,5-trimethylperoxyhexanoate as polymerization initiator and 19.6 g of 2-mercaptoethanol as molecular weight regulator, and also with 4.3 g of palmitic acid. The resultant mixture is charged to a polymerization cell and devolatilized for 10 minutes. It is then polymerized in a water bath for 6 hours at 60° C., and then for 30 hours at 55° C. water bath temperature. After about 30 hours the polymerization mixture reaches its maximum temperature of 126° C. Once the polymerization cell has been removed from the water bath, the polymer is heat-conditioned in the polymerization cell for a further 7 hours at 117° C. in an air cabinet.

The resultant copolymer is clear and almost colourless and has a V.N. (solution viscosity number to ISO 1628-6, 25° C., chloroform) of 48.7 ml/g. The flowability of the copolymer was determined to ISO 1133 at 230° C. with 3.8 kg as MVR=3.27 cm³/10 min.

Component a.) is the copolymer described above composed of 75% by weight of methyl methacrylate, 15% by weight of styrene and 10% by weight of maleic anhydride.

Component b.) was prepared as follows:

The core-shell-shell particles described below were prepared by means of emulsion polymerization according to the general preparation specification below. The emulsions I to III stated in Table 1 were used here.

19.416 kg of water were used as initial charge at 83° C. (internal tank temperature) in a polymerization tank. 16.2 g of sodium carbonate and 73 g of seed latex were added. Emulsion I was then metered in over 1 h. 10 min after the end of feed of emulsion I, emulsion II was metered in over a period of about 2 h. About 90 min after the end of feed of emulsion II, emulsion III was then metered in over a period of about 1 h. 30 min after the end of feed of emulsion III, the mixture was cooled to 30° C.

For separation of the core-shell particles, the dispersion was frozen at −20° C. over a period of 2 d, then thawed again, and the coagulated dispersion was separated off by way of a filter textile. The solid was dried at 50° C. in a drying cabinet (time: about 3 d).

The size of the core-shell particles was 234 nm, determined with the aid of Coulter N4 equipment, the particles being measured in dispersion.

TABLE 1
Make-up of individual emulsions (all data in
[g])

| Emulsion I | |
|---|---|
| Water | 8109.65 |
| Sodium persulphate | 8.24 |
| Aerosol OT 75 | 65.88 |
| Methyl methacrylate | 14 216.72 |
| Ethyl acrylate | 593.6 |
| Allyl methacrylate | 29.68 |
| Emulsion II | |
| Water | 7081.18 |
| Sodium persulphate | 18.59 |
| Aerosol OT 75 | 84.71 |
| Butyl acrylate | 17 744.4 |
| Styrene | 954 |
| Allyl methacrylate | 381.6 |
| Emulsion III | |
| Water | 2992.59 |
| Sodium persulphate | 8.24 |
| Aerosol OT 75 | 10.59 |
| Methyl methacrylate | 7632 |
| Ethyl acrylate | 848 |

The component c.) used comprised: a commercially available copolymer composed of 75% by weight of methyl methacrylate, 15% by weight of styrene and 10% by weight of maleic anhydride with a solution viscosity number to ISO 1628-6, 25° C., chloroform of 68 ml/g.

The component d.) used comprised: a commercially available copolymer composed of 99% by weight of methyl methacrylate and 1% by weight of methyl acrylate with a solution viscosity in chloroform at 25° C. (ISO 1628—Part 6) of from about 52 to 54 ml/g.

### INVENTIVE EXAMPLES 1 TO 3

### Example 1

Polymer mixture composed of:

Component a.): 50% by weight

Component b.): 15.6% by weight

Component c.): -

Component d.): 34.4% by weight

Lubricant: 0.1% by weight of stearyl alcohol (based on the entirety of components a.) to d.))

### Example 2

Polymer mixture composed of:

Component a.): 50% by weight

Component b.): 13% by weight

Component c.): 37% by weight

Component d.): -

Lubricant: 0.2% by weight of stearyl alcohol (based on the entirety of components a.) to d.))

### Example 3

Polymer mixture composed of:

Component a.): 52% by weight

Component b.): 9% by weight

Component c.): 39% by weight

Component d.): -

Lubricant: 0.2% by weight of stearyl alcohol (based on the entirety of components a.) to d.))

### COMPARATIVE EXAMPLES

### Comparative Examples 4-5

### Comparative Example 4

Polymer mixture composed of:

Component a.): 48% by weight

Metablen IR441: 19% by weight (impact modifier from Mitsubishi)

Component d.): 33% by weight

Lubricant: 0.1% by weight of stearyl alcohol (based on the entirety of components a.) to d.))

### Comparative Example 5

Polymer mixture composed of:

Component a.): 50% by weight

Metablen IR441: 13% by weight

Component c.): 37% by weight

Component d.): -

Lubricant: 0.2% by weight of stearyl alcohol (based on the entirety of components a.) to d.))

| | Inv. | Inv. | Inv. | Comp. | Comp. |
|---|---|---|---|---|---|
| Property | Ex. 1 | Ex. 2 | Ex. 3 | Ex. 4 | Ex. 5 |
| VSP | 112.1 | 118.76 | 119.9 | 109.2 | 116.1 |
| (° C.) | | | | | |
| IR | 63 | 68 | 57 | 34.4 | 16.1 |
| [kJ/m²] | | | | | |
| MVR | 3.0 | 1.5 | 1.9 | 3.3 | 2.2 |
| [cm³/10 min] | | | | | |

The results show that at relatively small impact modifier concentration of the inventive impact modifier, impact resistance (IR) becomes greater and Vicat softening point (VSP) rises.

1. Polymer mixture, which comprises the following components:
a. 25-75% by weight of a low-molecular-weight (meth)acrylate (co)polymer, composed of methyl methacrylate, styrene and maleic anhydride
characterized by a solution viscosity in chloroform at 25° C. (ISO 1628—Part 6) smaller than or equal to 55 ml/g
b. 7-60% by weight of an impact modifier based on crosslinked poly(meth)acrylates
c. 10-50% by weight of a relatively high-molecular-weight (meth)acrylate (co)polymer,
characterized by a solution viscosity in chloroform at 25° C. (ISO 1628—Part 6) greater than or equal to 65 ml/g and/or
d. 10-50% by weight of a relatively high-molecular-weight (meth)acrylate (co)polymer a further (meth)acrylate (co)polymer other than a),
characterized by a solution viscosity in chloroform at 25° C. (ISO 1628—Part 6) of from 50 to 55 ml/g
where each of the components a.), b.), c.) and/or d.) can be treated as individual polymer or else as a mixture of polymers,
where a.), b.), c.) and/or d.) give a total of 100% by weight and
where the polymer mixture can also comprise conventional additives, conventional auxiliaries and/or conventional fillers and
where a test specimen produced from the polymer mixture simultaneously has the following properties:
a tensile modulus (ISO 527) of at least 2 500 MPa,
a Vicat softening point VSP (ISO 306-B50) of at least 110° C.,
an impact resistance IR (ISO 179, edgewise) of at least 30 kJ/m², and
a melt index MVR (ISO 1133, 230° C./3.8 kg) of at least 1.0 cm³/10 min.

2. Polymer mixture according to claim 1, characterized in that component a.) is a copolymer composed of
from 50% by weight to 90% by weight of methyl methacrylate,
from 10% by weight to 20% by weight of styrene and
from 5% by weight to 15% by weight of maleic anhydride.

3. Polymer mixture according to one or more of claims 1 to 2, characterized in that component b.) has a core/shell/shell structure.

4. Core-shell particle according to claim 1, which has a core, a first shell and a second shell, where:
the core encompasses, based on its total weight, at least 75.0% by weight of (meth)acrylate repeat units;
the first shell has a glass transition temperature below 30° C.;
the second shell encompasses, based on its total weight, at least 75.0% by weight of (meth)acrylate repeat units;
characterized in that
the first shell encompasses, based on its total weight, the following constituents:
from 92.0 to 98.0% by weight of (meth)acrylate repeat units
and
from 2.0 to 8.0% by weight of styrenic repeat units of the general formula (I) 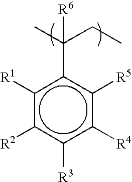
where each of the radicals R¹ to R⁵ independently of the others, is hydrogen, a halogen, a C₁₋₆-alkyl group or a C₂₋₆-alkenyl group and the radical R⁶ is hydrogen or an alkyl group having from 1 to 6 carbon atoms,
where the percentages by weight of E) and F) give a total of 100.0% by weight,
and that
the radius of the core-shell particle, inclusive of the second shell, measured by the Coulter method, is in the range from greater than 160.0 to 250.0 nm.

5. Core-shell particle according to claim 1, characterized in that, in each case based on its total weight,
the core makes up from 5.0 to 50.0% by weight,
the first shell makes up from 20.0 to 75.0% by weight and
the second shell makes up from 0.0 to 50.0% by weight,
where the percentages by weight give a total of 100.0% by weight.

6. Polymer mixture according to one or more of claims 1 to 5, characterized in that component c) is a copolymer composed of methyl methacrylate, styrene and maleic anhydride.

7. Polymer mixture according to claim 6, characterized in that component c) is a copolymer composed of
from 50% by weight to 90% by weight of methyl methacrylate,
from 10% by weight to 20% by weight of styrene and
from 5% by weight to 15% by weight of maleic anhydride.

8. Polymer mixture according to one or more of claims 1 to 7, characterized in that component d.) is a homopolymer or copolymer composed of at least 80% by weight of methyl methacrylate and where appropriate up to 20% by weight of other monomers copolymerizable with methyl methacrylate.

9. Polymer mixture according to claim 8, characterized in that component d.) is a copolymer composed of from 95% by weight to 99.5% by weight of methyl methacrylate and from 0.5% by weight to 5% by weight of methyl acrylate.

10. Polymer mixture according to one or more of claims 1 to 9, characterized in that a lubricant is present as auxiliary.

11. Polymer mixture according to claim 10, characterized in that stearyl alcohol is present as mould-release agent.

12. Injection moulding, composed of a polymer mixture according to one or more of claims 1 to 11.

13. Use of a polymer mixture according to one or more of claims 1 to 11 for production of injection mouldings which have the following properties:
I. a tensile modulus (ISO 527) of at least 2 500 MPa,
II. a Vicat softening point VSP (ISO 306-B50) of at least 110° C.,
III. an impact resistance (ISO 179-2D, flatwise) of at least 30 kJ/m², and
IV. a melt index MVR (ISO 1133, 230° C./3.8 kg) of at least 1.0 cm³/10 min.

14. Use of the injection mouldings according to claim 12 or 13 as parts of household equipment, of communication equipment, of hobby equipment or of sports equipment, or as bodywork parts or as parts of bodywork parts in automobile construction, shipbuilding or aircraft construction.
